(19) United States
(12) Patent Application Publication
(10) Pub. No.: US 2010/0321470 A1
(43) Pub. Date: Dec. 23, 2010

(54) IMAGING APPARATUS AND CONTROL METHOD THEREFOR

(75) Inventor: Hiroyuki OSHIMA, Kurokawa-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/814,996

(22) Filed: Jun. 14, 2010

(30) Foreign Application Priority Data
Jun. 22, 2009 (JP) 2009-147791

(51) Int. Cl. H04N 7/00

(52) U.S. Cl. 348/36; 348/E07.092

(57) ABSTRACT

A pantoscopic imaging apparatus includes first and second imaging units. First and second images simultaneously captured by the respective imaging units are displayed as live-view images in a dual-screen fashion on an LCD. Overlapping areas between the first and second images, which overlap with each other when the first and second images are synthesized to produce a panoramic image, are detected. A distance of the nearest subject to the imaging apparatus is determined among those subjects contained in the overlapping areas. If the nearest subject distance is less a predetermined threshold value, the nearest subject is displayed in a specific pattern within each of the live-view images, to give an alert to a potential error that would be caused by parallax in the panoramic image before it is produced from the first and second images.

### FIELD OF THE INVENTION

The present invention relates to an imaging apparatus that captures images of subjects from multiple points of view to produce a panoramic image, and relates also to a control method therefor.

### BACKGROUND OF THE INVENTION

Digital cameras have recently been spread, which capture an optical image of a subject by a solid state imaging device, such as a CCD image sensor, convert the optical image into image data, and record it on a recording medium, such as a built-in memory or a memory card. As a well-known type of digital camera, there is a pantoscopic imaging apparatus having multiple imaging units, each consisting of imaging optics and a solid state imaging device, as disclosed in JPA1992-67020.

The pantoscopic imaging apparatus captures a plurality of images simultaneously in different directions through the multiple imaging units, and then composes a panoramic image by synthesizing these images such a manner that they overlap one another in those marginal areas which correspond to each other, as disclosed in U.S. Pat. No. 6,005,987 (corresponding to JPA1998-178564).

Since the respective imaging units of the pantoscopic imaging apparatus capture images of the same subject from different points of view, the images captured by the different imaging units involve parallax therebetween. Although parallax may be defined in many different ways, it can be defined in this instance as a deviation between those pixels of the pantoscopic images which represent the same or corresponding point of the captured subject. The magnitude of parallax increases as the distance from the pantoscopic imaging apparatus to the subject decreases. Therefore, if the overlapping areas of the images to be synthesized contain any subject that is too close to the pantoscopic imaging apparatus, the image of such subject will be affected by the parallax, being blurred or doubled in the subsequent panoramic image (see FIG. 12B). This problem caused by the parallax in the composite panoramic image will be referred to as a synthetic error hereinafter.

### SUMMARY OF THE INVENTION

The present invention is provided to solve the above problem, and has an object to provide an imaging apparatus and a control method therefor, which enable us to avoid the synthetic error due to parallax.

To achieve the above object, the present invention provides an imaging apparatus, which comprises a plurality of imaging devices, each converting an optical image formed through a taking lens to an electronic image in an image capturing mode; an image synthesizer that synthesizes a plurality of images captured by the imaging devices to produce a panoramic image; a display device that displays the captured images individually in the image capturing mode; an overlapping area detection device for detecting overlapping areas between the captured images, the overlapping areas containing identical subjects and being matched with each other to produce the panoramic image; a subject distance measuring device for measuring a subject distance to a subject that is located the nearest to the imaging devices among those subjects contained in the overlapping areas; and an alert device that is actuated when the subject distance measured by the subject distance measuring device is less than a predetermined threshold value, to superimpose an alert pattern on the nearest subject in each of the captured images as displayed on the display device, thereby to alert that an error will occur at the nearest subject in the panoramic image as produced by the image synthesizer.

The subject distance measuring device preferably determines an angle subtended between a line connecting the subject to each of the imaging devices and a line connecting the imaging devices to each other on the basis of image data of the overlapping areas, and calculates the subject distance based on the determined angles and a known distance between the imaging devices according to the principle of stereo-ranging.

The imaging apparatus preferably has the image capturing mode and a reproduction mode. The panoramic image is produced in response to a shooting command and recorded on a recording medium in the image capturing mode, and the panoramic image is read out of the recording medium and reproduced to be displayed on the display device in the reproduction mode.

Preferably, the image capturing mode includes a still image capturing mode for recording a still image in response to the shooting command, and the imaging apparatus further comprises an operating device for inputting the shooting command, and a shooting command invalidating device for invalidating the shooting command from the operating device when the alerting device is actuated in the still image capturing mode.

Preferably, the image capturing mode includes a still image capturing mode for recording a still image in response to the shooting command, and the imaging apparatus further comprises an automatic imaging controller that outputs the shooting command automatically while the alerting device is not actuated in the still image capturing mode.

The image capturing mode preferably includes a moving image capturing mode, wherein a plurality of the panoramic images are successively produced by the image synthesizer and recorded as panoramic moving image frames constituting a moving image on the recording medium. Preferably, the imaging apparatus further comprises a recording controller for controlling recording the panoramic moving image frames on the recording medium so as not to record those of the panoramic moving image frames which are produced while the alerting device is actuated in the moving image capturing mode.

Preferably, the imaging apparatus further comprises an alert information tagging device for tagging alert information to the panoramic image when the alerting device is actuated for the panoramic image, the alert information alerting that the panoramic image is faulty.

Preferably, the imaging apparatus further comprises a first display controller that controls the display device to display the alert information together with the panoramic image if the alert information is tagged to the panoramic image as being read out from the recording medium in the reproduction mode.

The imaging apparatus may further comprise a second display controller that controls the display device not to display the panoramic image if the alert information is tagged to the panoramic image as being read out from the recording medium in the reproduction mode.

Where the image capturing mode includes a moving image capturing mode, wherein a plurality of the panoramic images are successively produced by the image synthesizer and recorded as panoramic moving image frames constituting a moving image on the recording medium, the second display controller preferably controls the display device to skip those panoramic moving image frames which are tagged with the alert information while displaying the panoramic moving image frames successively as one moving image in the reproduction mode.

Preferably, the imaging apparatus further comprises an interpolating frame producing device for producing an interpolating frame from preceding and succeeding normal frames to at least one panoramic moving image frame tagged with the alert information, wherein the second display control device controls the display device to display the interpolating frame in place of the at least one panoramic moving image frame to be skipped.

The present invention also provides a control method for controlling an imaging apparatus comprising a plurality of imaging devices, each converting an optical image formed through a taking lens to an electronic image in an image capturing mode, and an image synthesizer that synthesizes a plurality of images captured simultaneously by the imaging devices to produce a panoramic image. The method of the present invention comprises the steps of: displaying individual images as captured simultaneously by the imaging devices on a monitor in the image capturing mode; detecting overlapping areas between the captured images, the overlapping areas containing identical subjects and being matched with each other to produce the panoramic image; measuring a subject distance of a subject that is located the nearest to the imaging devices among those subjects contained in the overlapping areas; comparing the measured subject distance with a predetermined threshold value; and superimposing, if the measured subject distance is less than said predetermined threshold value, an alert pattern on the nearest subject in each of said captured images as displayed on said monitor, to alert that an error will occurs at the nearest subject in said panoramic image as produced by said image synthesizer.

The imaging apparatus and the method according to the present invention are configured to superimpose the alert pattern on the nearest subject within the overlapping areas of the respective images captured by the imaging devices, while these images are being displayed on the monitor or viewfinder screen of the imaging apparatus, if the distance of the nearest subject to the imaging devices is too short, i.e., less than the predetermined threshold value.

The superimposed alert pattern will make the user aware of the potential error that can occur in a panoramic image due to parallax, before the panoramic image is produced by the image synthesizer. Having the alert pattern superimposed thereon, the nearest subject is easy noticeable when its distance to the imaging devices is extremely short. Thus, the alert pattern may prompt the user to reframe the view field of the imaging apparatus so as to exclude the extremely near subject from the overlapping areas, or move sufficiently away from the nearest subject, thereby to avoid the synthetic error due to parallax.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a front perspective view of a pantoscopic imaging apparatus according to an embodiment of the present invention;

FIG. 2 is a rear perspective view of the pantoscopic imaging apparatus of FIG. 1;

FIG. 3 is a rear perspective view of the pantoscopic imaging apparatus

FIG. 4 is an explanatory diagram illustrating a process of detecting overlapping areas;

FIG. 5 is an explanatory diagram illustrating a process of calculating subject distances by stereo-ranging;

FIG. 6 is an explanatory diagram illustrating a data file structure of a panoramic still image;

FIG. 7 is an explanatory diagram illustrating a data file structure of a panoramic moving image;

FIG. 8 is a functional block diagram of a CPU;

FIG. 9 is a flowchart illustrating a sequence of imaging process for a still image;

FIG. 10 is an explanatory diagram illustrating a live-view image displayed on an LCD;

FIG. 11 is a flowchart illustrating a sequence of reproduction process for displaying a still image;

FIG. 12 is an explanatory diagram illustrating a still image reproduced and displayed on the LCD;

FIG. 13 is an explanatory diagram illustrating an index image displayed on the LCD;

FIG. 14 is a flowchart illustrating a sequence of imaging process for a moving image;

FIG. 15 is an explanatory diagram illustrating a sequence of reproduction process for displaying a moving image; and

FIG. 16 is an explanatory diagram illustrating a sequence of reproduction process for displaying a moving image, according to another embodiment, wherein an intermediate frame is produced.

### DESCRIPTION OF THE PREFERRED EMBODIMENTS

As shown in FIG. 1, a pantoscopic imaging apparatus (pantoscopic camera) 10 includes first and second imaging units 12 and 13 and a flash projector 14, which are located on the front of a camera body 11. The imaging units 12 and 13 are horizontally aligned at a predetermined spacing therebetween such that respective optical axes of these imaging units are substantially parallel to or tilt apart from each other toward objective side. The camera body 11 has a shutter button (operating member) 15 and a power switch 16 on its top side.

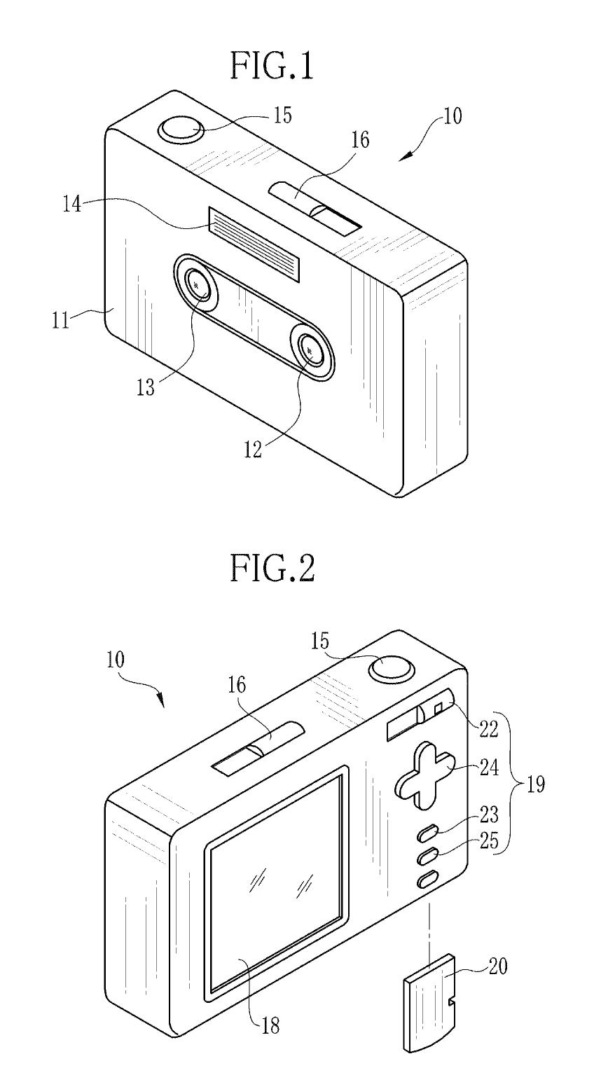

Referring to FIG. 2, a liquid crystal display device (LCD) 18 and an operating section 19 are placed on the back of the camera body 11. While the imaging apparatus 10 is functioning as a camera, the LCD 18 serves as an electronic viewfinder displaying live-view images (or called camera-through images). Note that the “live-view image” is a moving image displayed on the LCD 18 at the instance when it is captured by either of the imaging units (image sensors) 12 and 13. In a reproduction mode of the imaging apparatus 10, the LCD 18 can display images reproduced on the basis of image data that has been recorded on a memory card (recording medium) 20.

The operating section 19 includes a mode switch 22, a menu button 23, a cursor shift key 24 and an Enter key 25. The mode switch 22 is operated to switch over operation modes of the pantoscopic imaging apparatus 10. The operation modes include a still image capturing mode for capturing a wide-angle panoramic still image, a moving image capturing mode for capturing a wide-angle panoramic moving image, and the reproduction mode for reproducing and displaying the captured panoramic images on the LCD 18.

The menu button 23 is operated for the pantoscopic imaging apparatus 10 to display a menu screen or a setup screen on the LCD 18. The cursor shift key 24 is operated to shift a cursor on the menu screen or the setup screen. The Enter key 25 is operated to fix setup conditions of the camera. The operating section 19 may include other elements and the respective elements may be used for other operations than the above mentioned ones.

The pantoscopic imaging apparatus 10 can be optionally set into an automatic imaging condition, a shooting operation invalidating condition, a faulty frame recording block condition, a faulty image reproduction block condition. The automatic imaging is for capturing a panoramic still image automatically when the pantoscopic imaging apparatus 10 judges that it can capture a good image, independently of the shutter button 15.

The shooting operation invalidation is to invalidate a press on the shutter button 15 when a panoramic still image, which would otherwise be captured upon this operation, would not be a good one. The faulty frame recording block is to avoid recording faulty image frames of a panoramic moving image among those frames captured in the moving image capturing mode. Hereinafter, the image frames of the panoramic moving image will be referred to as panoramic moving image frames. The faulty image reproduction block is to prohibit reproducing faulty panoramic images in the reproduction mode, whether they are panoramic still images or panoramic moving image frames.

Although it is omitted from the drawings, a card slot for selectively inserting a memory card 20 and a lid for opening or closing the card slot are provided on the bottom of the camera body 11.

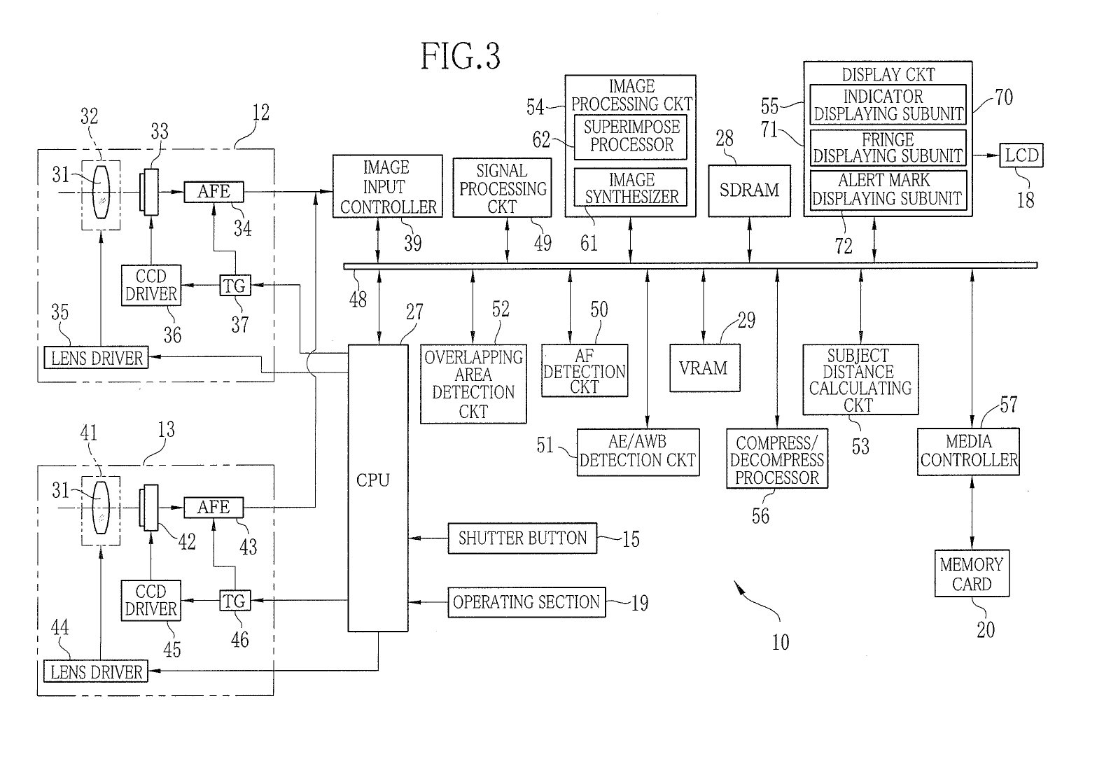

Referring to FIG. 3, a CPU 27 totally controls respective components of the pantoscopic imaging apparatus 10 by executing various programs and data as read out from a not-shown ROM in response to input signals from the shutter button 15 and the operating section 19.

SDRAM 28 serves as a work memory for the CPU 27 to execute the processing. VRAM 29 includes a live-view memory area capable of storing successive two fields of image data, to store temporarily image data for displaying the live-view images.

The first imaging unit 12 includes a lens unit 32 having a taking lens 31 incorporated therein, a CCD image sensor (hereinafter referred to simply as CCD) 33, and an AFE (analog front end circuit) 34. The CCD may be replaced with a MOS type image sensor.

Zooming, focusing and stopping mechanisms are also incorporated in the lens unit 32. The zooming mechanism moves the taking lens 31 for zooming. The focusing mechanism moves a focus lens, which is included in the taking lens 31, to focus the taking lens 31 on a subject. The stopping mechanism adjusts a not-shown stop aperture to control the intensity of light that travels from the subject and falls onto the imaging device 33. These operations of the zooming, focusing and stopping mechanisms are controlled via a lens driver 35 by the CPU 27.

The imaging device 33 has a photoreceptive surface, on which a large number of photodiodes are arranged in a matrix. The photoreceptive surface is located behind the taking lens 31, so that the light from the subject enters through the taking lens 31 and is converted to and output as an electronic image signal through the imaging device 33. The imaging device 33 is connected to a CCD driver 36 that is controlled by the CPU 27. The CCD driver 36 is driven by synchronizing pulses which are generated from a timing generator (TG) 37, to control charge-storage time and charge-readout timing of the imaging device 33.

The image signal output from the imaging device 33 is fed to the AFE 34, which consists of a correlated double sampling (CDS) circuit, an automatic gain control (AGC) amplifier, and an A/D converter. The AFE 34 is supplied with the synchronizing pulses from the TG 37, so the AFE 34 operates in synchronism with the reading and transferring operation of the charge from the CCD 33. The CDS circuit reduces noises from the image signal through correlated double sampling. The AGC amplifier amplifies the image signal at a gain corresponding to the sensitivity of the imaging unit 12, as determined by the CPU 27. The A/D converter converts the analog image signal from the AGC to a digital image signal, and outputs the digital image signal to an image input controller 39. Hereinafter, the digital image signal output from the first imaging unit 12 will be referred to as the left image signal.

The second imaging unit 13 has the same structure as the first imaging unit 12, including a lens unit 41, a CCD 42, an AFE 43, a lens driver 44, a CCD driver 45 and a TG 46, and outputs a digital image signal as a right image signal to the image input controller 39.

The CPU 27 is connected through a bus 48 to the SDRAM 28, the VRAM 29, the image input controller 39, a signal processing circuit 49, an autofocus (AF) detection circuit 50, an auto-exposure (AE)/auto-white balance (AWB) detection circuit 51, an overlapping area detection circuit 52, a subject distance calculating circuit 53, an image processing circuit 54, a display circuit 55, a compress/decompress processor 56, a media controller 57 and so forth. Hereinafter, the overlapping area detection circuit 52 will be referred to simply as the area detection circuit 52.

The image input controller 39 has a buffer memory of a predetermined capacity for storing the right and left image signals from the imaging units 12 and 13 to the extent that the stored right and left image signals constitute one frame each. Then, the image input controller 39 outputs the right and left image signals frame by frame to the signal processing circuit 49.

The signal processing circuit 49 processes the right and left image signals from the image input controller 39 with many kinds of image-processing procedures, such as gradation conversion, white-balance correction, gamma correction and Y/C conversion, to produce a pair of image data frames corresponding to a pair of right and left images to be synthesized into a panoramic image, which are then stored in the VRAM 29.

The AF detection circuit 50 calculates an AF evaluation value, which evaluates the contrast between the right and left image frames, based on the right and left image signals from the image input controller 39. On the basis of the AF evaluation value from the AF detection circuit 50, the CPU 27 controls the lens drivers 35 and 44 to adjust the focus of the taking lens 31.

The AE/AWB detection circuit 51 detects subject brightness and calculates a white-balance evaluation value for use in the white-balance correction, on the basis of the right and left image signals. The CPU 27 controls the lens drivers 35 and 44 and the CCD drivers 36 and 45 to control the exposure on the basis of the subject brightness information from the AE/AWB detection circuit 51. The CPU 27 also controls the signal processing circuit 49 on the basis of the white-balance evaluation value from the AE/AWB detection circuit 51, so as to get a proper white-balance of the subject in the captured image.

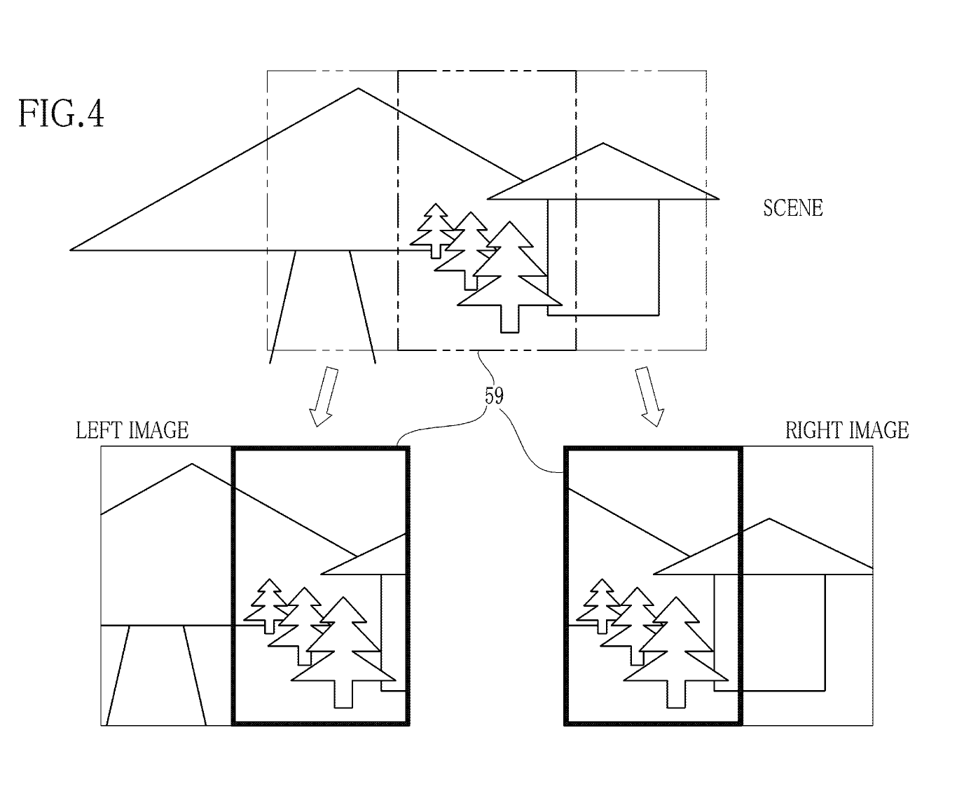

Referring to FIG. 4, it shows an example of a pair of right and left images which correspond to the right and left image data frames stored in the VRAM 29. The overlapping area detection circuit 52 detects an overlapping area 59, as fringed with bold lines in FIG. 4, from each of the right and left images. The overlapping areas 59 can be definitely determined by the spacing between the imaging units 12 and 13, in combination with the zoom ratio and other parameters. Among these parameters, the spacing or distance between the imaging units 12 and 13 is a fixed or known value. Therefore, the overlapping area detection circuit 52 is provided with a ROM (not shown) that previously memorizes data representative of variable ranges of the overlapping areas 59, which vary with the zoom ratio. The overlapping area detection circuit 52 refers to the ROM to determine the overlapping areas 59 of the right and left images on the basis of the zoom ratio. It is to be noted that the method of detecting the overlapping areas 59 is not limited to the above method, but any suitable methods are applicable.

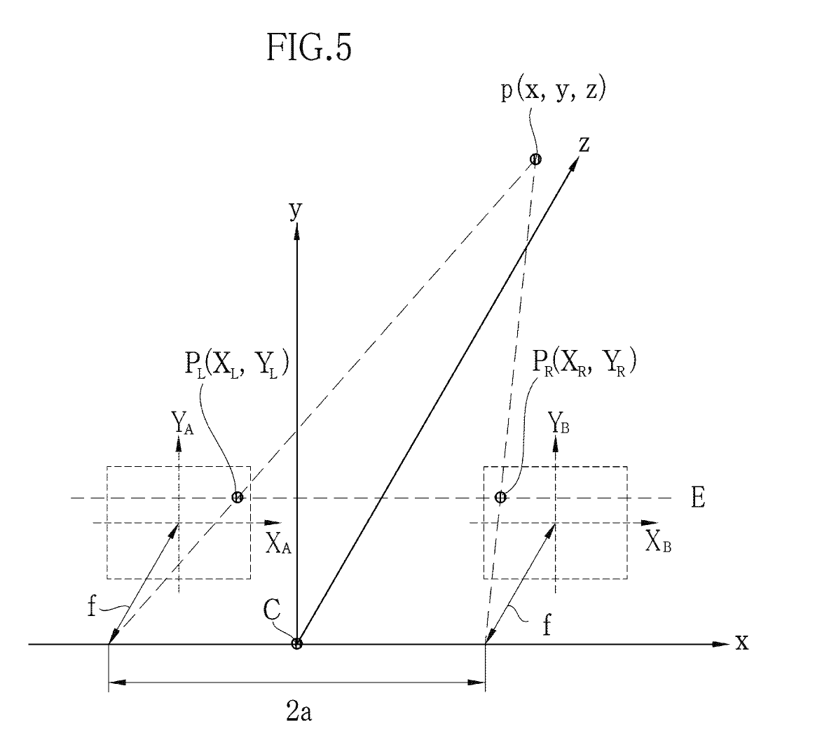

The subject distance calculating circuit 53 calculates subject distances from the pantoscopic imaging apparatus 10 to those subjects contained in the overlapping areas 59. Specifically, the subject distance calculating circuit 53 calculates the subject distance with respect to every pixel included in the overlapping areas 59; it calculates the subject distance to each point of the contained subjects, which corresponds to each pixel of the overlapping areas 59, by means of the principle of stereo-ranging. The principle of stereo-ranging will be described below with reference to FIG. 5.

In FIG. 5, a coordinate space (x, y, z) represents a real space, while a coordinate plane (X, Y) represents an image plane of each of a couple of cameras, the image plane corresponding to the imaging surface of each of the first and second imaging units 12 and 13. To discriminate between the two cameras or the first and second imaging units 12 and 13, coordinates (XL, YL) are used for the left-hand camera, and coordinates (XR, YR) are used for the right-hand camera. In these coordinate systems, x-axis of the coordinate space and X-axis, i.e. XA-axis and XB-axis of the coordinate planes for the left-hand and the right-hand cameras, are provided to be parallel to each other. Also, y-axis of the coordinate space and Y-axis, i.e. YA-axis and YB-axis of the coordinate planes for the left-hand and right-hand cameras, are provided to be parallel to each other, whereas z-axis is provided to be parallel to optical axes of these cameras. The origin of the coordinate system is located at an intermediate point C between principal points of the right- and left-hand cameras in the real space, and a distance between these principal points will be called a reference length and represented by 2a. The distance between the principal point and the image plane, i.e. the focal length, is represented by f.

A point “p” in the real space is assumed to be projected onto a point PL (XL, YL) and a point PR (XR, YR) on the left and right image planes respectively. In the stereo-ranging, the points PL and PR on the image planes are determined so as to calculate coordinates (x, y, z) of the point “p” in the real space by means of triangulation. Since the optical axes of the right and left cameras are on the same plane, and the x-axis is parallel to the XA axis and the XB axis, the ordinates YL and YR have the same value. The relation between the coordinates (XL, YL) and (XR, YR) on the image planes and the coordinates (x, y, z) in the real space may be given by either the following formula (1) or formula (2), wherein “d”=XL−XR that represents the parallax, and “a” is a half of the reference length 2a:

$$\begin{matrix}x = \frac{a ( {X}_{L} + {X}_{R} )}{d} , y = \frac{2 aY}{d} , z = \frac{2 af}{d} & ( 1 ) \\ {X}_{L} = \frac{( x + a ) f}{z} , {X}_{R} = \frac{( x - a ) f}{z} , {Y}_{L} = {Y}_{R} = \frac{yf}{d} & ( 2 )\end{matrix}$$

Because “a” is more than zero, it is determined according to the formula (2) that XL>XR and YL=YR. This indicates that corresponding points on one and the other image planes are on the same scanning line that is an epipolar line E, as well as in the range of XL>XR. Accordingly, the correspondence between one point on one image plane and another point on the other image plane can be detected only by evaluating the similarity between the right and left images with respect to a narrow zone along a straight line on which the corresponding points may exist. That is, where the optical axes of the two cameras are set to be parallel, like the illustrated example, the search range for the corresponding points can be restricted, although the whole overlapping areas of both images are usually searched to detect corresponding points to evaluate the similarity between these areas. Thus, the coordinates (x, y, z) of the point “p” is calculated, so the distance to the subject at the point “p” may be calculated.

Referring back to FIG. 3, the subject distance calculating circuit 53 carries out the stereo-ranging with respect to every pixel in the overlapping areas 59, to detect the subject distance of each corresponding point. The subject distance calculating circuit 53 then produces subject distance data that represents the relation between the coordinate position of each pixel in the overlapping areas 59 and the corresponding subject distance.

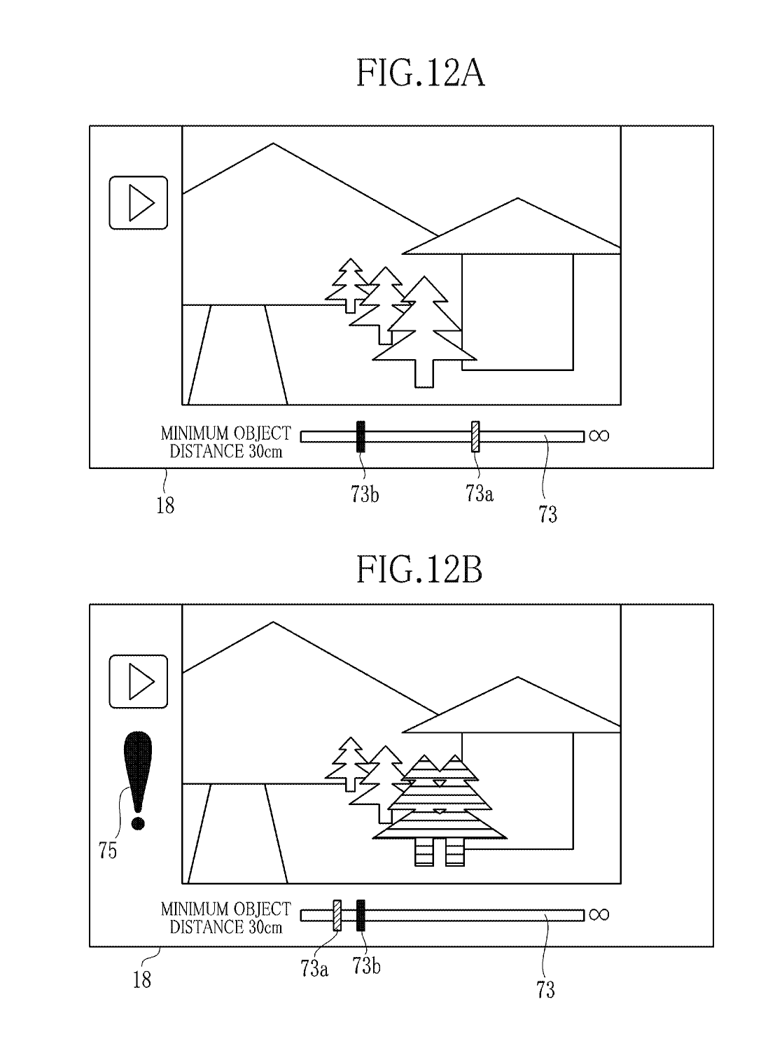

The image processing circuit 54 includes an image synthesizer 61 and a superimpose processor 62. Upon an instruction to capture an image, the image synthesizer 61 reads the right and left image data frames out of the VRAM 29, and synthesizes them to be a panoramic image data frame, as shown for example in FIG. 12, such that the overlapping areas 59 of the right and left images are aligned or matched up with each other. Such a panoramic image data frame may be produced according to a known method as disclosed for example in JPA 1997-091407.

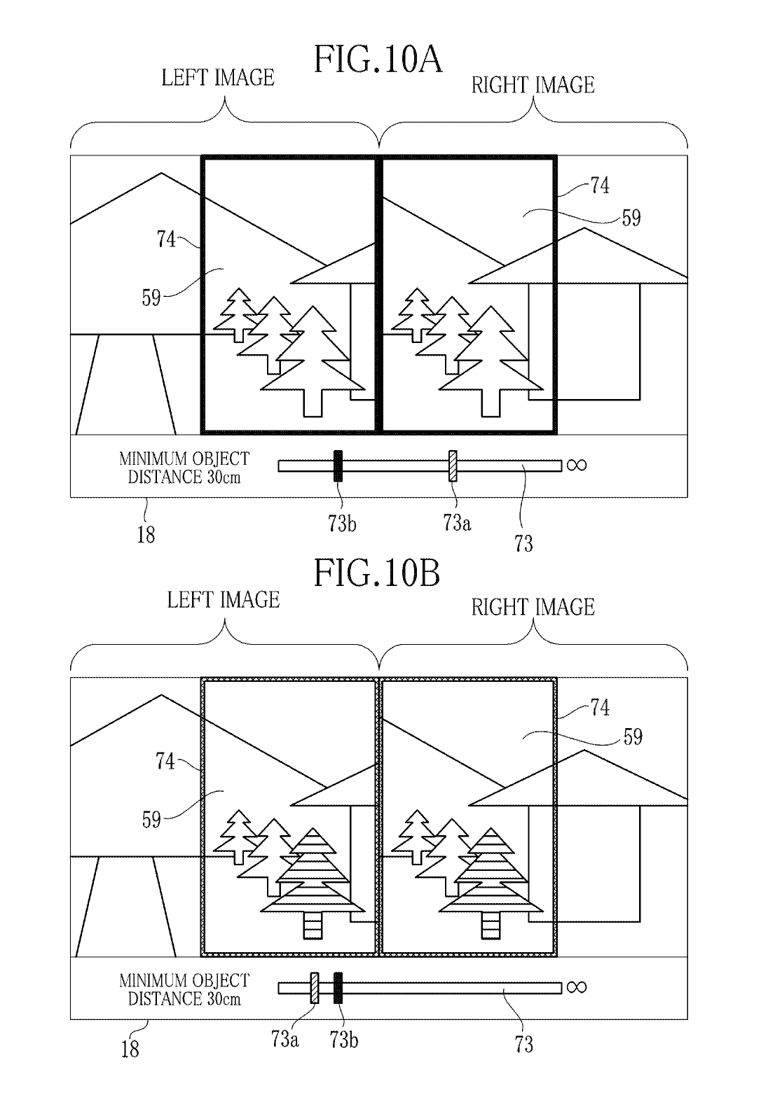

The superimpose processor 62 serves as an alert device of the present invention, which is actuated when a synthetic error can occur in a panoramic image data frame that is being produced by the image synthesizer 61. The synthetic error in the panoramic image data frame can be caused by the parallax when there is a subject that is extremely near to the pantoscopic imaging apparatus 10 in the overlapping area 59, while the right and left image data frames are so synthesized as to match such a subject that exits far enough from the pantoscopic imaging apparatus 10, e.g. landscapes. As a result, the nearest subject to the pantoscopic imaging apparatus 10 may be doubled or blurred in the synthetic image, as shown for example in FIG. 12B, or may disappear from the synthetic image. When actuated, the superimpose processor 62 superimposes an alerting zebra pattern (see FIG. 10) on each of the right and left image data frames as stored in the VRAM 29, over those areas corresponding to the nearest subject within the overlapping areas 59.

The compress/decompress processor 56 compresses the panoramic image data from the image synthesizer 61, to produce a panoramic image file of a predetermined compression format, before it is written on the memory card 20. The compress/decompress processor 56 also decompresses a compressed panoramic image file as read out from the memory card 20, to reproduce uncompressed panoramic image data. The media controller 57 controls writing and reading of the compressed image files on the memory card 20.

For example, a panoramic still image may be compressed to an image file of JPEG format compatible to Exif format; a panoramic moving image may for example be compressed to an image file of Motion JPEG format, wherein individual moving image frames are compressed to JPEG frames and compiled into one file.

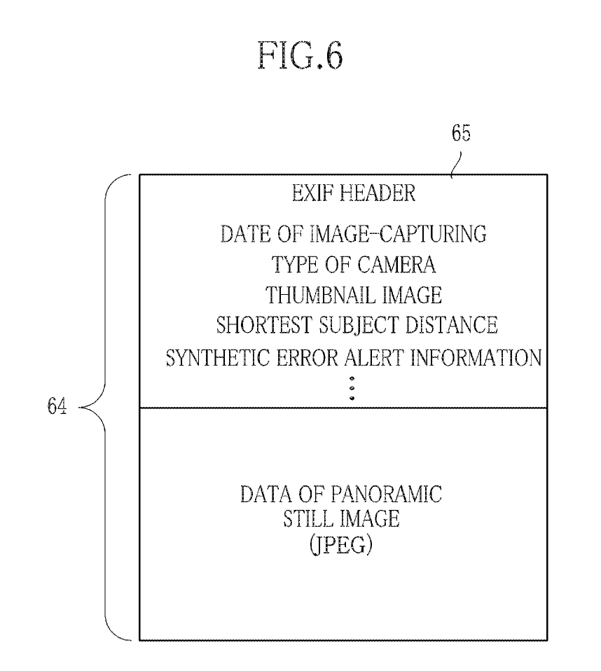

As shown in FIG. 6, a panoramic still image file 64 stores tag information in its Exif header 65. The tag information may include the date of capturing the image, the type of camera used, a thumbnail image, shortest subject distance information, and synthetic error alert information. The shortest subject distance information represents a subject distance to the nearest subject. The synthetic error alert information will be included in the tag information when a synthetic error is found in the panoramic image data of this file.

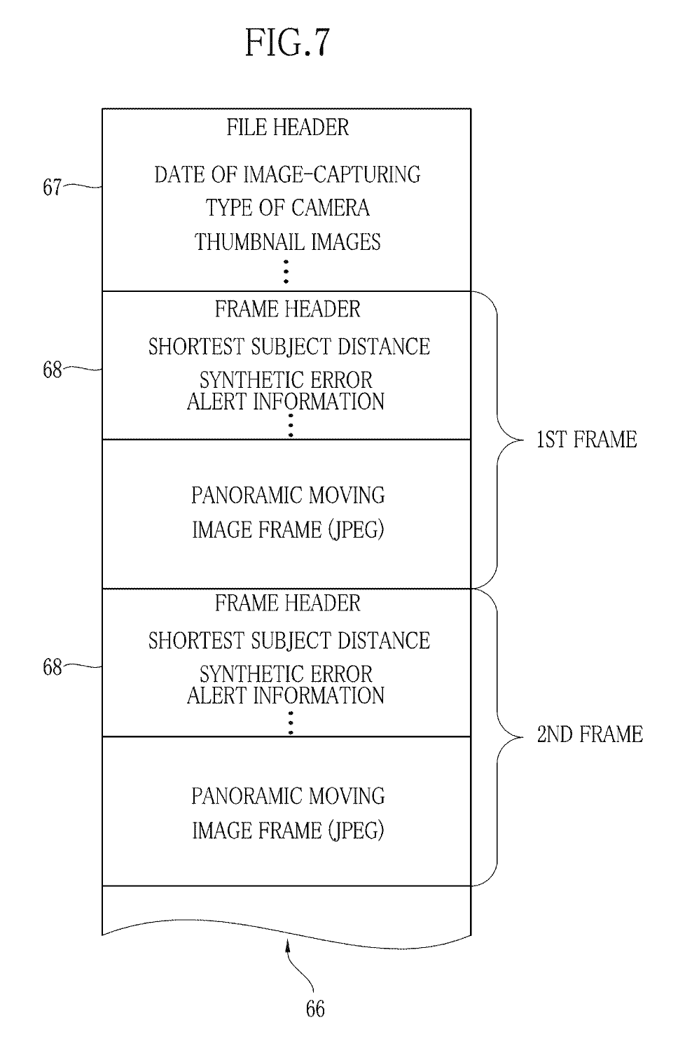

As shown in FIG. 7, a panoramic moving image file 66 includes a file header 67 storing the date of capturing the moving image, the type of camera used, thumbnails and other information therein. Following to the file header 67, panoramic moving image frames are recorded at regular time intervals to constitute the panoramic moving image file 66. Each panoramic moving image frame is attended by tag information, which is stored in a frame header 68 and includes the shortest subject distance information like the tag information of the file 64. If there is a synthetic error in the related panoramic moving image frame, the tag information further includes the synthetic error alert information. FIG. 7 explicitly shows a first frame and a second frame.

Referring back to FIG. 3, the display circuit 55 processes the right and left image data frames from the VRAM 29 through certain image-processing procedures in the still image capturing mode and the moving image capturing mode, thereby to produce a signal for displaying an image and output it at a constant time interval to the LCD 18. Thus, in the still image capturing mode and the moving image capturing mode, the LCD 18 displays a pair of live-view images at the same time as they are captured by the imaging units 12 and 13, on the same (dual) screen as shown for example in FIG. 10. In the reproduction mode, the display circuit 55 processes uncompressed panoramic image data from the compress/decompress processor 56, as obtained by decompressing image data as read out from the memory card 20, to produce a signal for displaying a reproduced panoramic still image or moving image on the LCD 18.

The display circuit 55 includes an indicator displaying subunit 70, a fringe displaying subunit 71, and an alert mark displaying subunit (first display control device) 72. The indicator displaying subunit 70 is for displaying an indicator 73 (see FIGS. 10 and 12) in an indicator display area on the LCD 18, to indicate the shortest subject distance based on the shortest subject distance information, which is calculated from the above-mentioned subject distance data in a real time fashion in the image capturing mode, or obtained from the tag information attached to the reproduced panoramic image data.

The fringe displaying subunit 71 is for superimposing a fringe 74 (see FIG. 10) on each of the right and left live-view images to indicate the respective overlapping areas 59 on the LCD 18. The fringe displaying subunit 71 is configured to display the fringe 74 in blue when the shortest subject distance is not less than a predetermined threshold value, or display the fringe in red when the shortest subject distance is less than the threshold value.

The alert mark displaying subunit 72 is actuated in the reproduction mode when the synthetic error alert information is tagged to the uncompressed panoramic image data from the compress/decompress processor 56. The alert mark displaying subunit 72 displays a synthetic error alert mark 75, hereinafter referred to simply as the alert mark, in an alert mark display area on the LCD 18, to alert that there is a synthetic error in the reproduced image.

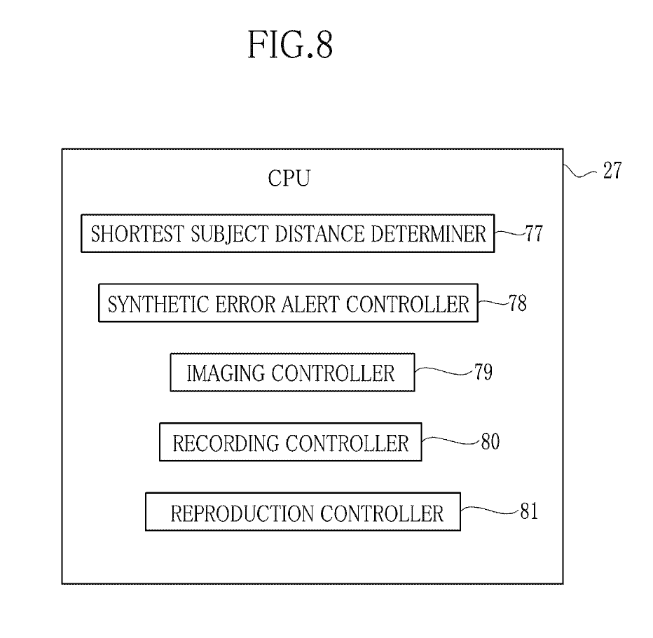

As shown in FIG. 8, the CPU 27 may function as a shortest subject distance determiner 77, a synthetic error alert controller 78, an imaging controller 79, a recording controller 80 and a reproduction controller 81, while reading and executing requisite programs and various kinds of data from the ROM.

The shortest subject distance determiner 77 constitutes a subject distance measuring device of the present invention, in cooperation with the subject distance calculating circuit 53. The shortest subject distance determiner 77 determines the shortest subject distance based on the subject distance data from the subject distance calculating circuit 53. In one example, the shortest subject distance may be the smallest value selected from among the subject distances included in the subject distance data. Alternatively, the shortest subject distance may be calculated as a mean value of subject distances at those pixels which constitute the nearest subject, which may be determined on the basis of the coordinate positions of the respective pixels and the subject distances included in the subject distance data.

The synthetic error alert controller 78 controls the superimpose processor 62 to superimpose the zebra pattern on the nearest subject in either of the right and left images by processing the image data frames stored in the VRAM 29 when the shortest subject distance determined by the shortest subject distance determiner 77 is less than the predetermined threshold value.

The imaging controller 79 corresponds to an automatic imaging controller of the present invention as well as to a shooting command invalidating device of the present invention. The imaging controller 79 controls capturing a still image. While the pantoscopic imaging apparatus 10 is set in the above-mentioned automatic imaging condition, the imaging controller 79 outputs a shooting command automatically when the shortest subject distance is not less than the threshold value, regardless of whether the shutter button 15 is pressed or not. While the pantoscopic imaging apparatus 10 is set in the above-mentioned shooting operation invalidating condition, the imaging controller 79 invalidates a shooting command as entered by pressing the shutter button 15, if the shortest subject distance is less than the threshold value.

The recording controller 80 corresponds to an alert information tagging device of the present invention as well as to a recording controller of the present invention. The recording controller 80 controls compression and decompression of the panoramic image data, storage of the tag information, and record of the compressed image data on the memory card 20. The recording controller 80 also controls the compress/decompress processor 56 so that the synthetic error alert information is tagged to such a panoramic image data frame that suffers a synthetic error, hereinafter referred to as a faulty image frame. In addition, while the pantoscopic imaging apparatus 10 is set in the faulty frame recording block condition in the moving image capturing mode, the recording controller 80 controls the compress/decompress processor 56 and the media controller 57 so as not to record such faulty image frames.

The reproduction controller 81 corresponds to a second display controller of the present invention, which controls the display circuit 55 for reproducing and displaying panoramic still image or panoramic moving image. While the pantoscopic imaging apparatus 10 is set in the faulty image reproduction block condition, the reproduction controller 81 controls the display circuit 55 so as not to reproduce and display such panoramic image data frames that are tagged with the synthetic error alert information.

Now the overall operation of the pantoscopic imaging apparatus 10 will be described. Upon the power switch 16 being turned on, the CPU 27 is loaded with a control program from the ROM, to start controlling the operation of the pantoscopic imaging apparatus 10. Thereafter, the pantoscopic imaging apparatus 10 can be set into desirable conditions by manipulating the operating section 19, including the menu button 23, the cursor shift key 24 and the Enter key 25; the automatic imaging condition, the shooting operation invalidating condition, the faulty frame recording block condition and the faulty image reproduction block condition are independently selected to be ON or OFF.

[Still Image Capturing Mode]

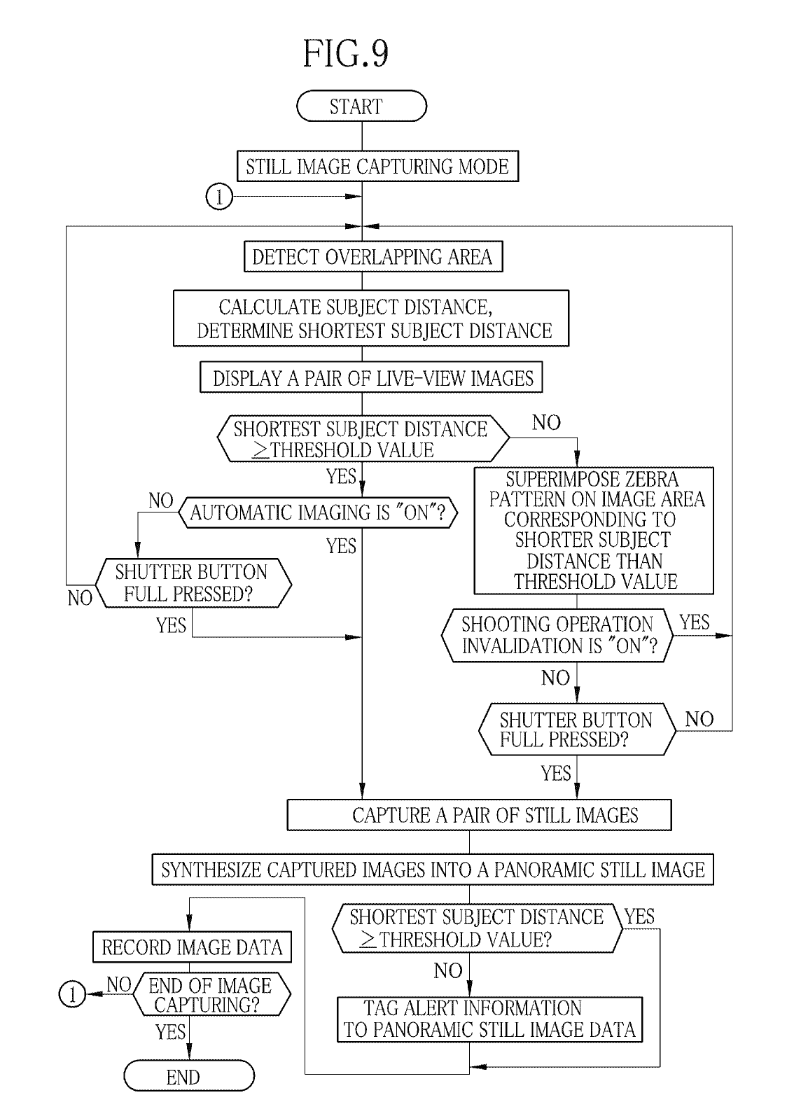

Referring to the flowchart of FIG. 9, the mode switch 22 is operated to set the pantoscopic imaging apparatus 10 to the still image capturing mode, to capture panoramic still images. Optical images formed through the respective taking lenses 31 of the imaging units 12 and 13 are converted to electronic images through the CCD 33 and 42, and then to digital image signals through the AFE 34 and 43, respectively. The right and left image signals from the imaging units 12 and 13 is fed to the signal processing circuit 49 via the image input controller 39, to be processed appropriately to produce a pair of right and left image data frames. The right and left image data frames are written in the VRAM 29.

After writing the right and left image data frames, the CPU 27 outputs an overlapping area detection command to the overlapping area detection circuit 52. Upon this command, the overlapping area detection circuit 52 detects the overlapping area 59 in each of the right and left image data frames as written in the WRAM 29, and sends a detection result to the CPU 27. Upon receipt of the overlapping area detection result, the CPU 27 sends the result along with a subject distance calculation command to the subject distance calculating circuit 53.

Upon the subject distance calculation command, the subject distance calculating circuit 53 calculates a subject distance with respect to every pixel in either overlapping area 59 on the basis of the right and left image data and the overlapping area detection result, thereby to produce the subject distance data. The subject distance calculating circuit 53 outputs the subject distance data to the CPU 27.

The shortest subject distance determiner 77 of the CPU 27 determines the shortest subject distance based on the subject distance data from the subject distance calculating circuit 53, and outputs the shortest subject distance information to the synthetic error alert controller 78. The synthetic error alert controller 78 compares the threshold value with the shortest subject distance obtained from the shortest subject distance determiner 77.

[Shortest Subject Distance≧Threshold Value]

When the shortest subject distance is not less than the threshold value, the CPU 27 outputs the overlapping area detection result and the shortest subject distance information to the display circuit 55, along with a live-view image display command. Upon the live-view image display command, the display circuit 55 reads out the right and left image data frames from the VRAM 29 to control the LCD 18 to display the right and left live-view images.

As shown in FIG. 10A, the right and left live-view images are displayed in a dual-screen fashion on the LCD 18. At the same time, the indicator displaying subunit 70 displays the indicator 73 in the indicator display area on the LCD 18, on the basis of the shortest subject distance information obtained from the CPU 27. The indicator 73 includes a bar slider 73a for indicating the shortest subject distance and a bar slider 73b for indicating the threshold value. In addition, the fringe displaying subunit 71 displays the fringe 74 in blue, as illustrated by bold lines, superimposed on either of the right and left live-view images, to indicate the overlapping areas 59 on the basis of the overlapping area detection result obtained from the CPU 27. Thus, the user can frame a field of view while comparing the present shortest subject distance with the threshold value.

Referring back to FIG. 9, when the automatic imaging condition is OFF, the AF detection circuit 50 and the AE/AWB detection circuit 51 are actuated upon the shutter button 15 being pressed halfway, to execute preparatory processes, such as focus control and exposure control.

When the shutter button 15 is fully pressed after the preparatory processes are accomplished, the image signals read out from the CCDs 33 and 42 are processed respectively in the AFEs 34 and 43 and then in the signal processing circuit 49, and the obtained right and left image data frames are written in the VRAM 29. Thereafter, the CPU 27 outputs an image synthesizing command to the image synthesizer 61.

Upon the image synthesizing command, the image synthesizer 61 reads out the right and left image data frames from the VRAM 29 and synthesizes these frames to form a panoramic still image. The panoramic still image is then fed to the compress/decompress processor 56. The compress/decompress processor 56 compresses the panoramic still image into a panoramic still image file 64 of JPEG format, in response to a compression command from the recording controller 80. The compressed image data or panoramic still image file 64 is written on the memory card 20 via the media controller 57.

When the automatic imaging condition is ON, the imaging controller 79 outputs a shooting command to the respective components of the pantoscopic imaging apparatus 10. Upon this shooting command, the preparatory processes are executed, the image signals are read out from the CCDs 33 and 42, and processed into the right and left image data frames, and the right and left image data frames are temporarily written in the VRAM 29, synthesized into a panoramic still image, and compressed into a panoramic still image file 64. Since the shortest subject distance is not less than the threshold value, the panoramic still image does not contain any synthetic error. Thus, the file 64 is written on the memory card 20.

[Shortest Subject Distance<Threshold Value]

On the contrary, when the shortest subject distance is less than the threshold value, the synthetic error alert controller 78 first determines those pixels constituting the nearest subject on the basis of the subject distance data, including the coordinate position of each pixel and the corresponding subject distance. For example, where the nearest subject is a tree, pixels constituting the tree are substantially equal in subject distance. On the other hand, subjects in back of the nearest subject, like a mountain and a house in the illustrated example, have remarkably larger subject distances than the nearest subject, so that it is possible to identify the pixels of the nearest subject. Next, the synthetic error alert controller 78 outputs coordinate position data of the identified pixels of the nearest subject and a superimpose command to the superimpose processor 62.

Upon the superimpose command, the superimpose processor 62 reads out the right and left image data frames from the VRAM 29. The superimpose processor 62 then processes the right and left image data frames to superimpose the zebra pattern on the pixels constituting the nearest subject, with reference to the coordinate position data from the synthetic error alert controller 78. The right and left image data frames having been superimposed with the zebra pattern are rewritten in the VRAM 29.

At the end of the superimposing process, the CPU 27 sends a live-view image display command to the display circuit 55, along with the overlapping area detection result and the shortest subject distance information, thereby to cause the LCD 18 to display the right and left live-view images.

As shown in FIG. 10B, the LCD 18 displays the right and left live-view images based on the right and left image data frames as processed by the superimpose processor 62, with the zebra pattern superimposed on the nearest subject. In addition, the bar slide 73a for indicating the shortest subject distance is displayed at a point representative of a smaller value than the threshold value as indicated by the bar slider 73b. Moreover, the fringe 74 is displayed in red, as implied by half-tone screening in FIG. 10B. Thus, the pantoscopic imaging apparatus 10 can give an alert to the user that the synthetic error would occur in the panoramic still image when the user makes a shooting operation by pressing the shutter button 15. The alert will prompt the user to reframe the view field of the pantoscopic imaging apparatus 10 so as to exclude the extremely near subject from the overlapping areas 59, or move backward to keep sufficiently away from the nearest subject, thereby to avoid the synthetic error due to parallax.

Referring back to FIG. 9, when the shooting operation invalidating condition is ON, and where the shortest subject distance is less than the threshold value, the imaging controller 79 invalidates the shooting command from the shutter button 15 even if the user presses the shutter button 15 in spite of the above-mentioned alert. Thus, the pantoscopic imaging apparatus 10 is prevented from producing a faulty panoramic still image with a synthetic error or from recording the faulty panoramic still image on the memory card 20.

On the other hand, when the shooting operation invalidating condition is OFF, the preparatory processes are executed upon a half press on the shutter button 15, and then a panoramic still image is produced from the right and left image data frames in the manner as described above upon a full press on the shutter button 15.

Thereafter, the recording controller 80 outputs the compression command and an alert information tag command to the compress/decompress processor 56. In response to the compression command, the compress/decompress processor 56 compresses the panoramic still image. In response to the alert information tag command, the compress/decompress processor 56 also records the synthetic error alert information in the Exif header 65 of the panoramic still image file 64 of the compressed image data. The panoramic still image file 64 is written on the memory card 20 via the media controller 57. The same procedures as above are repeated until the pantoscopic imaging apparatus 10 is put out of the still image capturing mode.

[Reproduction Mode for Panoramic Still Image]

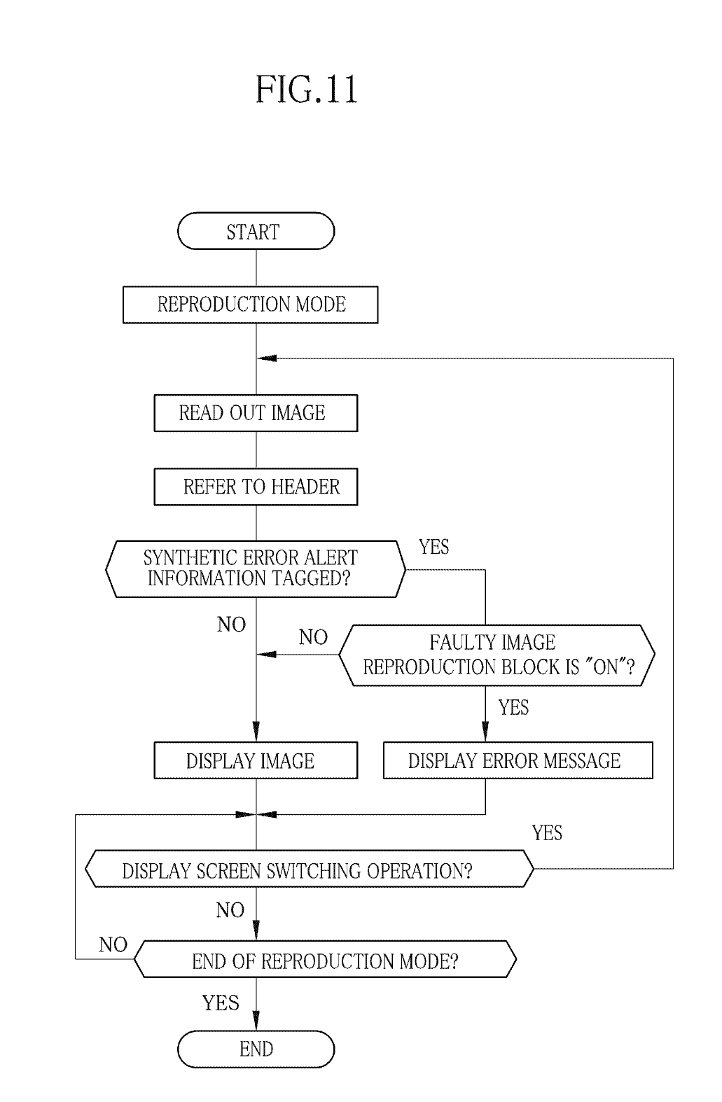

As shown in FIG. 11, the mode switch 22 is operated to set the pantoscopic imaging apparatus 10 to the reproduction mode, to reproduce and display the panoramic still images recorded on the memory card. As the reproduction mode is set up, the CPU 27 outputs a thumbnail display command to the media controller 57, upon which the thumbnails of the recorded images are readout from the memory card 20 and fed to the display circuit 55. Thus, the LCD 18 displays an index image consisting of the thumbnails of the recorded images arranged sequentially in an array.

When an image to be reproduced is selected by choosing its thumbnail with the cursor shift key 24 and the Enter key 25 for example, the CPU 27 outputs a corresponding read-out command to the media controller 57, to feed the compressed image data of the selected image from the memory card 20 to the compress/decompress processor 56. The CPU 27 also outputs a decompression command to the compress/decompress processor 56, so the compress/decompress processor 56 decompresses or converts the compressed image data to uncompressed image data of the selected panoramic still image, and outputs the uncompressed image data to the display circuit 55.

If no synthetic error alert information is tagged to the panoramic still image data, or when the faulty image reproduction block is OFF, the reproduction controller 81 outputs a reproduction command to the display circuit 55. Upon the reproduction command, the display circuit 55 activates the LCD 18 to display the panoramic still image.

As shown in FIG. 12A, the panoramic still image with no synthetic error alert information is displayed on the LCD 18 without any synthetic error. The indicator displaying subunit 70 displays the indicator 73 in the indicator display area on the LCD 18, according to the shortest subject distance information that is tagged to the panoramic still image data.

On the other hand, in the case of a faulty panoramic still image that is tagged with the synthetic error alert information, the nearest subject, which assumes a synthetic error in the panoramic still image, is displayed with the zebra pattern on the LCD 18. In addition, the alert mark displaying subunit 72 is activated to display the alert mark 75 in the alert mark display area on the LCD 18. Thus, it becomes apparent that this image is faulty.

Referring back to FIG. 11, if the synthetic error alert information is tagged to the panoramic still image data and the faulty image reproduction block is ON, the reproduction controller 81 of the CPU 27 outputs an error message display command to the display circuit 55. Upon the error message display command, the display circuit 55 causes the LCD 18 to display an error message, such as “a synthetic error in the selected image” for example, instead of the faulty image. Thus, the time taken to look at the faulty image is skipped, so the user can browse the recorded images with improved efficiency.

The same procedures as above are repeated each time an image is selected to be reproduced so long as the pantoscopic imaging apparatus 10 is set in the reproduction mode.

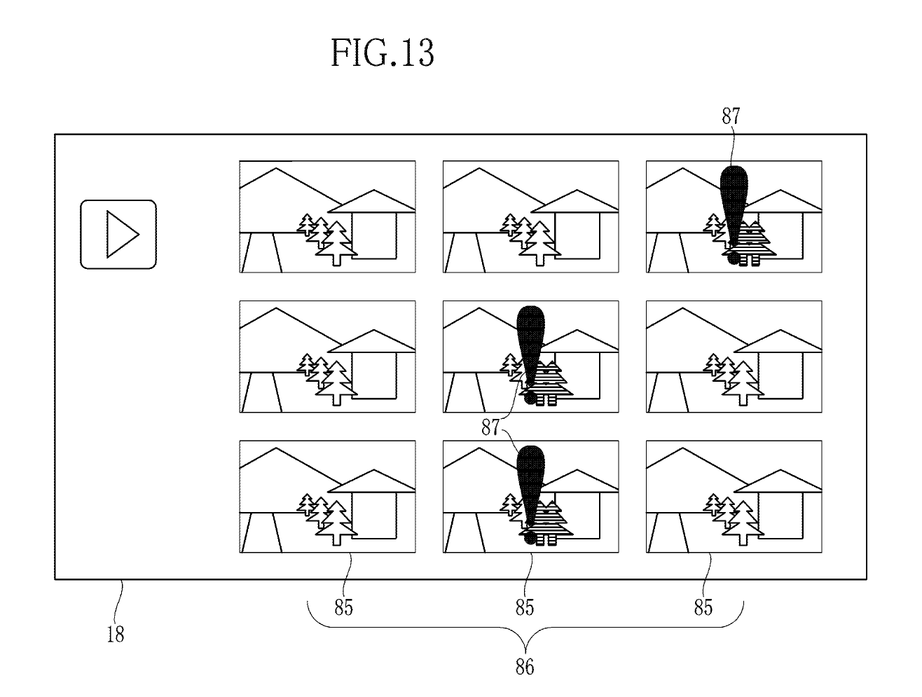

It should be appreciated that an alert mark 87 may be superimposed on each of the thumbnails 85 of the faulty images, when displayed as an index image 86 on the LCD 18, as shown in FIG. 13, on the basis of the synthetic error alert information tagged to the image data of these faulty images. Thus, the user can avoid selecting the faulty images, so the efficiency of image-browsing is more improved.

[Moving Image Capturing Mode]

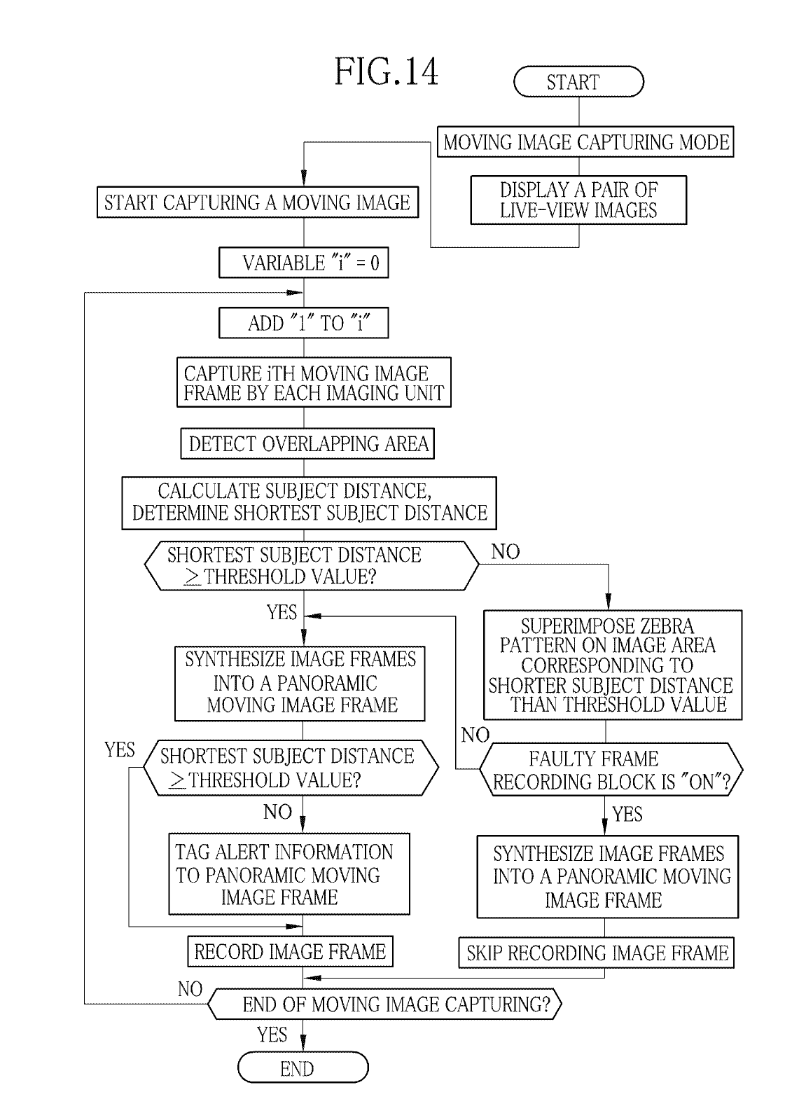

Now the operation of the pantoscopic imaging apparatus 10 in the moving image capturing mode will be described with reference to the flowchart of FIG. 14. When the mode switch 22 is operated to set the pantoscopic imaging apparatus 10 to the moving image capturing mode, the LCD 18 displays right and left live-view images on the dual-screen in the same way as in the still image capturing mode. Upon the shutter button 15 being pressed to the full, the pantoscopic imaging apparatus 10 starts capturing image frames of a panoramic moving image at a constant frame rate (e.g. 30 frames per second). Captured right and left image data frames are sequentially written in the VRAM 29.

Each time a pair of right and left image data frames are written in the VRAM 29, the same procedures as for capturing panoramic still images are executed sequentially in the same way as described above; determining the overlapping areas 59 of these frames, calculating the subject distance with respect to every pixel, determining the shortest subject distance of the nearest subject contained in the overlapping area 59, and comparing the detected shortest subject distance with the threshold value. If the shortest subject distance is not less than the threshold value, the CPU 27 controls the image synthesizer 61 to produce a panoramic moving image frame from the right and left image data frames, and output the panoramic moving image frame to the compress/decompress processor 56.

On the contrary, if the shortest subject distance is less than the threshold value, the CPU 27 controls the superimpose processor 62 to superimpose the zebra pattern on the right and left image data frames, and the image synthesizer 61 produces a panoramic moving image frame from those right and left image data frames having the zebra pattern superimposed thereon, and outputs the panoramic moving image frame to the compress/decompress processor 56. The compress/decompress processor 56 compresses the panoramic moving image frame seriatim as it is fed from the image synthesizer 61.

If the panoramic moving image frame to be compressed is a faulty one containing the synthetic error, and when the faulty frame recording block is OFF, the recording controller 80 outputs the alert information tag command to the compress/decompress processor 56. Upon the alert information tag command, the compress/decompress processor 56 records the synthetic error alert information in the frame header 68 of the faulty moving image frame. Thereafter, the moving image frame is compressed according the predetermined format and recorded sequentially in a file of the predetermined format (see FIG. 7) on the memory card 20.

If the panoramic moving image frame to be compressed is a faulty one, and when the faulty frame recording block is ON, the recording controller 80 outputs a skip command to the compress/decompress processor 56 and the media controller 57. Upon the skip command, the compress/decompress processor 56 and the media controller 57 skip the faulty moving image frame, that is, the faulty moving image frame is not recorded on the memory card 20. Thus, the waste of the recording capacity of the memory card 20 is minimized. Alternatively, when the faulty frame recording block is ON, those right and left image data frames containing such a subject in their overlapping areas that is determined to have a shorter distance than the threshold value may be eliminated before the synthesizing process.

The same procedures as above are repeated until the shutter button 15 is pressed again to the full to stop capturing the moving image. A series of compressed moving image frames captured this way are united and recorded as one panoramic moving image file 66 on the memory card 20.

[Reproduction Mode for Panoramic Moving Image]

To reproduce the panoramic moving image from the memory card 20 and display it on the LCD 18, the mode switch 22 is operated to set the pantoscopic imaging apparatus 10 to the reproduction mode. Upon being set to the reproduction mode, the pantoscopic imaging apparatus 10 displays an index image on the LCD 18, consisting of an array of thumbnails of recorded panoramic moving image files 66, like in the above-described reproduction process for panoramic still images.

When a thumbnail in the index image is selected as a moving image to be reproduced, by operating the cursor shift key 24 and the Enter key 25 for example, the CPU 27 outputs a corresponding read-out command to the media controller 57, to read out the compressed moving image frames of the selected panoramic moving image file 66, and feed these moving image frames sequentially to the compress/decompress processor 56. The CPU 27 also outputs a decompression command to the compress/decompress processor 56, so the compress/decompress processor 56 sequentially decompresses or converts the compressed moving image frames to uncompressed moving image frames and sequentially outputs the uncompressed moving image frames to the display circuit 55.

When the faulty image reproduction block is OFF, the reproduction controller 81 outputs the reproduction command to the display circuit 55 each time the panoramic moving image frame is input in the display circuit 51.

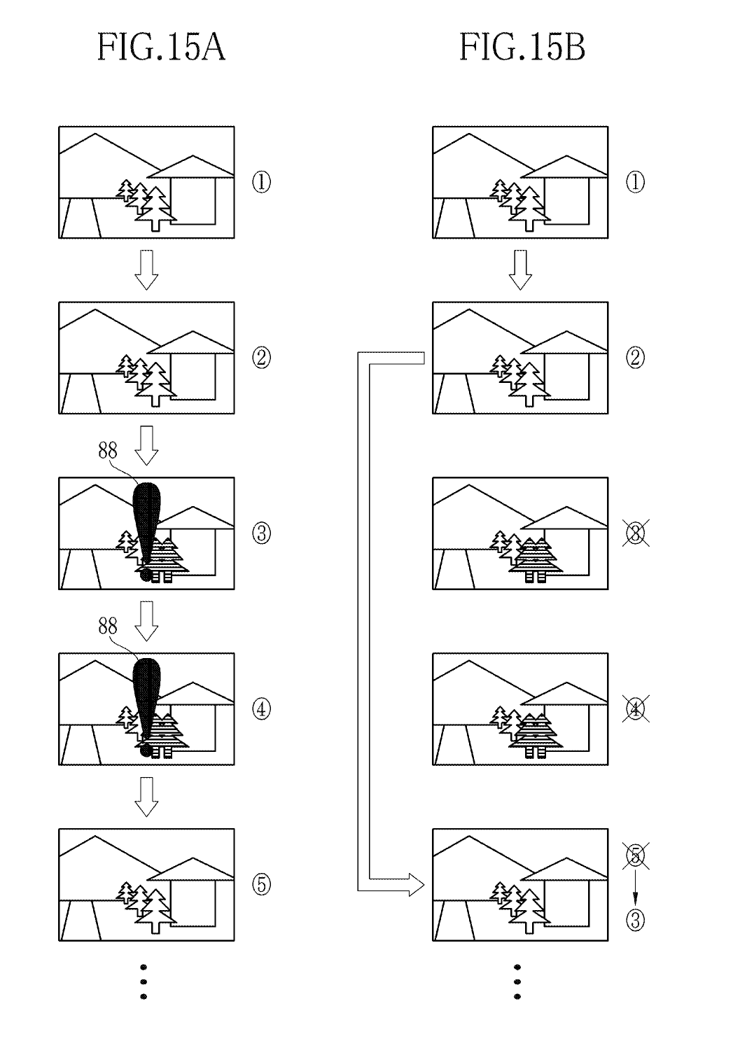

As shown in FIG. 15A, the display circuit 55 controls the LCD 18 to display the panoramic moving image frames in a continuous succession, responding to the reproduction commands. Among these frames, the faulty moving image frames tagged with the synthetic error alert information are each displayed with an alert mark 88 superimposed thereon, like the third and fourth frames in the illustrated example.

On the other hand, when the faulty image reproduction block is ON, the reproduction controller 81 outputs the skip command to the display circuit 55 each time the faulty moving image frame is input to the display circuit 55.

Upon the skip command, the display circuit 55 avoids displaying the faulty moving image frame. As shown for example in FIG. 15B, where the third and fourth moving image frames are faulty ones, the third and fourth frames are skipped on the LCD 18; the reproduced moving image skips from the second frame to the fifth frame. This will reduce the waste of time of displaying the faulty imaging frame.

So long as the reproduction mode is effective, the same procedures as above are repeated each time a moving image file is selected to be reproduced.

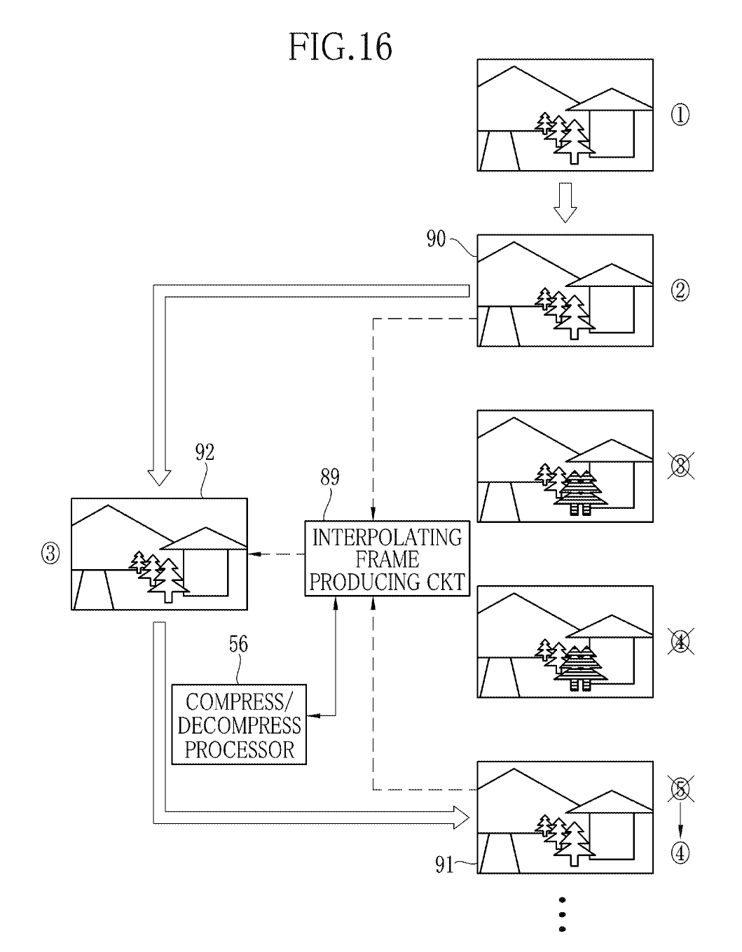

In an alternative embodiment, interpolating frames are produced and displayed in place of the faulty moving image frames on the LCD 18 during the reproduction of the moving image, as shown in FIG. 16. In the second embodiment, those components which are equal or equivalent in function or structure to the first embodiment are designated by the same reference numerals, so that the description of these components will be omitted with respect to the second embodiment.

As shown in FIG. 16, an interpolating frame producing circuit 89 is connected to the compress/decompress processor 56. The interpolating frame producing circuit 89 is actuated when the faulty image reproduction block is ON and when the panoramic moving image frame as decompressed by the compress/decompress processor 56 is a faulty one. Then the interpolating frame producing circuit 89 produces an interpolating frame from preceding and succeeding normal panoramic moving image frames to the faulty moving image frame.

In an example, the interpolating frame producing circuit 89 analyzes the preceding and succeeding normal image frames, to extract some characteristic points that constitute a contour of a main subject, such as a person, a building or a vehicle. Next, the characteristic points of the preceding frame are compared with the characteristic points of the succeeding frame, to identify a portion as a common main subject, where the characteristic points of the preceding and succeeding frames overlap. Then coordinate values of the main subject in the preceding frame and coordinate values of the main subject in the succeeding frame are averaged to calculate coordinate values of the main subject in an interpolating frame. Thereafter, a background image is synthesized with the main subject on the basis of the preceding and succeeding normal, to produce the interpolating image frame.

The produced interpolating image frame is output as a substitute for the faulty image frame to the display circuit 55. For example, where the third and fourth moving image frames are faulty ones, an interpolating image frame 92 is produced from the second and fifth moving image frames 90 and 91, and is output to the display circuit 55. Thus, the LCD 18 displays the interpolating image frame 92 after the second moving image frame, in place of the third and fourth moving image frames. The interpolating image frame 92 serves to minimize deterioration in resolution of the moving image caused by the frame-skipping, as well as avoid black-out of the moving image, which would result from the lack of some frames.

In the above first embodiment, if the shortest subject distance is less than the predetermined threshold value in the still image capturing mode or in the moving image capturing mode, the nearest subject having the too short subject distance is displayed with the zebra pattern superimposed thereon. However, the present invention is not limited to the first embodiment, but other methods of indicating the nearest subject may be usable to facilitate visual discrimination of such an extremely near subject in the image. For example, the extremely near subject may be displayed with other pattern than the zebra pattern superimposed thereon, or may be displayed in red or in a blinking fashion. It may also be possible to display a variable alert message on the LCD 18.

In the above first embodiment, the subject distance calculating circuit 53 calculates the subject distance according to the stereo-ranging principle, the method of determining the subject distance is not limited to this embodiment, but may be other known appropriate method.

In the above first embodiment, the alert marks 75, 87 and 88 are displayed as an exclamation point “!” on the LCD 18, but this is not limitative. Any other symbols and marks may serve as the alert marks. The position and size of the alert marks may also be changed appropriately. An alerting message may be displayed instead of the alert mark, to warn of the faulty image.

In the above second embodiment, an interpolating image frame is produced and displayed on the LCD 18 in place of the skipped faulty moving image frames. In an alternative embodiment, the preceding normal moving image frame may be frozen to be displayed in place of the faulty moving image frames.

In the above first embodiment, the nearest subject in the overlapping areas 59 has been described as a single subject. It is however possible to determine more than one subject, whether they may be human subjects or not, as the nearest subject and indicate them in a specific alerting pattern if they in an extremely near range to the pantoscopic imaging apparatus 10, i.e. the subject distance range shorter than the threshold value. It is also be possible to put variations in alerting pattern and/or in color between the subjects to be indicated as extremely near subjects, depending on their distances to the pantoscopic imaging apparatus 10.

In the above first embodiment, if the shortest subject distance is less than the predetermined threshold value, the nearest subject is displayed with the zebra pattern in the live-view images. However, the extremely near subject may be displayed in many other alerting patterns, including a hatching pattern and a fringing pattern that surrounds the nearest subject for example. The alerting pattern may also be displayed in a blinking fashion.

Although the above described embodiments relate to the pantoscopic imaging apparatus, the present invention is also applicable to other kinds of imaging apparatuses that produce a panoramic image based on a plurality of images captured by a plurality of imaging devices, including an imaging apparatus that consists of a plurality of camera units and a main body controlling these camera units and processing signals from these camera units.

While the present invention has been described with reference to the specific embodiments thereof, it should be understood by those skilled in the art that various changes may be made and equivalents may be substituted without departing from the true spirit and scope of the invention.

What is claimed is:

1. An imaging apparatus comprising:
a plurality of imaging devices, each converting an optical image formed through a taking lens to an electronic image in an image capturing mode;
an image synthesizer that synthesizes a plurality of images captured by said imaging devices to produce a panoramic image;
a display device that displays said captured images individually in said image capturing mode;
an overlapping area detection device for detecting overlapping areas between said captured images, said overlapping areas containing identical subjects and being matched with each other to produce said panoramic image;
a subject distance measuring device for measuring a subject distance to a subject that is located the nearest to said imaging devices among those subjects contained in said overlapping areas; and
an alert device that is actuated when the subject distance measured by said subject distance measuring device is less than a predetermined threshold value, to superimpose an alert pattern on the nearest subject in each of said captured images as displayed on said display device, thereby to alert that an error will occur at said nearest subject in said panoramic image as produced by said image synthesizer.

2. The imaging apparatus as claimed in claim 1, wherein said subject distance measuring device determines an angle subtended between a line connecting said subject to each of said imaging devices and a line connecting said imaging devices to each other on the basis of image data of said overlapping areas, and calculates said subject distance based on the determined angles and a known distance between said imaging devices according to the principle of stereo-ranging.

3. The imaging apparatus as claimed in claim 1, wherein said panoramic image is produced in response to a shooting command and recorded on a recording medium in said image capturing mode, and said panoramic image is read out of said recording medium and reproduced to be displayed on said display device in a reproduction mode.

4. The imaging apparatus as claimed in claim 3, wherein said image capturing mode includes a still image capturing mode for recording a still image in response to said shooting command, said imaging apparatus further comprising an operating device for inputting said shooting command, and a shooting command invalidating device for invalidating said shooting command from said operating device when said alerting device is actuated in said still image capturing mode.

5. The imaging apparatus as claimed in claim 3, wherein said image capturing mode includes a still image capturing mode for recording a still image in response to said shooting command, said imaging apparatus further comprising an automatic imaging controller that outputs said shooting command automatically while said alerting device is not actuated in said still image capturing mode.

6. The imaging apparatus as claimed in claim 3, wherein said image capturing mode includes a moving image capturing mode, wherein a plurality of said panoramic images are successively produced by said image synthesizer and recorded as panoramic moving image frames constituting a moving image on said recording medium;
said imaging apparatus further comprising a recording controller for controlling recording said panoramic moving image frames on said recording medium so as not to record those of said panoramic moving image frames which are produced while said alerting device is actuated in said moving image capturing mode.

7. The imaging apparatus as claimed in claim 3, further comprising an alert information tagging device for tagging alert information to said panoramic image when said alerting device is actuated for said panoramic image, said alert information alerting that said panoramic image is faulty.

8. The imaging apparatus as claimed in claim 7, further comprising a first display controller that controls said display device to display said alert information together with said panoramic image if said alert information is tagged to said panoramic image as being read out from said recording medium in said reproduction mode.

9. The imaging apparatus as claimed in claim 7, further comprising a second display controller that controls said display device not to display said panoramic image if said alert information is tagged to said panoramic image as being read out from said recording medium in said reproduction mode.

10. The imaging apparatus as claimed in claim 9, wherein said image capturing mode includes a moving image capturing mode, wherein a plurality of said panoramic images are successively produced by said image synthesizer and recorded as panoramic moving image frames constituting a moving image on said recording medium, and wherein said second display controller controls said display device to skip those panoramic moving image frames which are tagged with said alert information while displaying said panoramic moving image frames successively as one moving image in said reproduction mode.

11. The imaging apparatus as claimed in claim 10, further comprising an interpolating frame producing device for producing an interpolating frame from preceding and succeeding normal frames to at least one panoramic moving image frame tagged with said alert information, wherein said second display control device controls said display device to display said interpolating frame in place of said at least one panoramic moving image frame to be skipped.

12. A control method for controlling an imaging apparatus comprising a plurality of imaging devices, each converting an optical image formed through a taking lens to an electronic image in an image capturing mode, and an image synthesizer that synthesizes a plurality of images captured simultaneously by said imaging devices to produce a panoramic image, said method comprising the steps of:
displaying individual images as captured simultaneously by said imaging devices on a monitor in said image capturing mode;
detecting overlapping areas between said captured images, said overlapping areas containing identical subjects and being matched with each other to produce said panoramic image;
measuring a subject distance of a subject that is located the nearest to said imaging devices among those subjects contained in said overlapping areas;
comparing the measured subject distance with a predetermined threshold value; and
superimposing, if the measured subject distance is less than said predetermined threshold value, an alert pattern on the nearest subject in each of said captured images as displayed on said monitor, to alert that an error will occurs at the nearest subject in said panoramic image as produced by said image synthesizer.
